(19) United States
(12) Patent Application Publication
(10) Pub. No.: US 2013/0009372 A1
(43) Pub. Date: Jan. 10, 2013

(54) WHEELCHAIR ATTACHMENT WITH SELECTIVELY DEPLOYABLE SECONDARY FRONT WHEELS

(75) Inventor: Paten WILLIS, Cumming, GA (US)

(73) Assignee: Georgia Health Sciences University Research Institute, Inc., Augusta, GA (US)

(21) Appl. No.: 13/539,623

(22) Filed: Jul. 2, 2012

Related U.S. Application Data
(60) Provisional application No. 61/504,732, filed on Jul. 6, 2011.

(51) Int. Cl. A61G 5/00

(52) U.S. Cl. 280/86.5

(57) ABSTRACT

An attachment for a wheelchair includes a secondary front-wheel pair that is movable from a disengaged up position, to a deployed down position, and back again. In the disengaged up position, the secondary front wheels are up off the ground, so the primary front wheels of the wheelchair are in contact with the ground and thereby being used. In the deployed down position, the secondary front wheels are down in contact with the ground and are thereby being used, so the primary front wheels are now removed from contact with the ground and are no longer in use. In typical embodiments, the secondary front wheels are relatively larger wheels for traversing rough terrain, the primary front wheels are relatively smaller wheels for traversing smooth terrain, and the secondary front wheels move between the disengaged up position and the deployed down position in a pivoting motion.

### CROSS-REFERENCE TO RELATED APPLICATION

This application claims the priority benefit of U.S. Provisional Patent Application Ser. No. 61/504,732, filed Jul. 6, 2011, which is hereby incorporated herein by reference.

### TECHNICAL FIELD

The present invention relates generally to wheelchairs, and more particularly to wheelchairs for use in outdoor activities involving traversing rough terrain.

### BACKGROUND

Conventional wheelchairs include a pair of large rear wheels and a pair of much smaller front wheels. The size (diameter and width) and construction of the relatively small front wheels are selected for ease of traversing smooth terrain such as indoor flooring, outdoor sidewalks and other walkways, etc. Such smooth-terrain, relatively-small, conventional front wheels are typically about three inches in diameter and about one-half inch wide. But some persons in wheelchairs enjoy outdoor activities involving traversing rough terrain. Such activities include hunting, camping, shooting, and other sports and recreational activities. There have been developed specialized “sports” or “low-profile” wheelchairs that typically are light-weight, mobile, and can be lifted into a car with one hand. These chairs typically are made of a light-weight material (e.g., aluminum) and include a footrest that is adjustable up and down (but not readily removable). And some such wheelchairs have been designed with larger front wheels designed to allow the chair to traverse rough terrain such as grass, wooded areas with fallen leaves and branches, uneven and/or soft ground, etc. Such rough-terrain, relatively-large, conventional front wheels are typically about six inches to about eight inches in diameter and about one inch to about two inches wide. But these “sports” or “low-profile” wheelchairs generally are not highly suitable for conventional use traversing smooth terrain.

Accordingly, it can be seen that there exists a need for improvements to wheelchairs to provide for use on both smooth and rough terrain. It is to the provision of solutions to this and other needs that the present invention is primarily directed.

### SUMMARY

Generally described, the present invention relates to an attachment for a wheelchair that permits use on smooth or rough terrain without having to get out go the chair and change front wheels. The attachment includes a secondary front-wheel set that is movable from a disengaged up position, to a deployed down position, and back again. In the disengaged up position, the secondary front wheels are up off the ground, so the primary front wheels of the wheelchair are in contact with the ground and thereby being used. In the deployed down position, the secondary front wheels are down in contact with the ground and are thereby being used, so the primary front wheels are now removed from contact with the ground and are no longer in use. In typical embodiments, the secondary front wheels are relatively larger wheels for traversing rough terrain, the primary front wheels are relatively smaller wheels for traversing smooth terrain, and the secondary front wheels move between the disengaged up position and the deployed down position in a pivoting motion.

In example embodiments, the wheelchair attachment includes at least two pivot arms, at least two secondary front wheels, at least one cross member, and at least one operating handle. The pivot arms mount to the wheelchair frame, the secondary front wheels are mounted to bottom sections of the pivot arms, the cross member extends between the pivot arms, and the operating handle(s) are position on upper sections of the pivot arms. In use, the user pushes the operating handle(s) forward to pivotally deploy the secondary front wheels and pulls the handles backward to pivotally disengage them.

In some embodiments, the wheelchair attachment is provided as a retrofit device for installation on existing wheelchairs. In other embodiments, the attachment is integrally provided as a component of new wheelchairs. The wheelchair can be of a conventional type that is known in the art or it can be specially designed for use with the attachment.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a perspective view of a secondary front-wheel attachment according to a first example embodiment of the present invention, showing the secondary front wheels installed on a wheelchair and in a disengaged up position.

FIG. 2 is a perspective view of the wheelchair and the secondary front-wheel attachment of FIG. 1, showing the secondary front wheels in a deployed down position.

FIG. 3 is a perspective view of the secondary front-wheel attachment of FIG. 1, shown detached from and without the wheelchair.

FIG. 4 is a perspective view of the wheelchair and the secondary front-wheel attachment of FIG. 1, showing portions of the attachment disassembled for compact storage of the attachment.

FIG. 5 shows the wheelchair and the secondary front-wheel attachment of FIG. 4 with the attachment disassembled and compactly stored.

FIG. 6 is a side view of a secondary front-wheel attachment according to a second example embodiment of the present invention, showing the secondary-wheel pair installed on a wheelchair and in a deployed down position.

FIG. 7 shows the wheelchair and the secondary front-wheel attachment of FIG. 6 with the secondary-wheel pair pivoting through an intermediate position.

FIG. 8 shows the wheelchair and the secondary front-wheel attachment of FIG. 7 with the secondary front wheels pivoted farther to a disengaged up position.

FIG. 9 is a perspective view of a wheelchair for use with a secondary front-wheel attachment according to a second example embodiment of the present invention, with the secondary front wheels not shown.

FIG. 10 shows the wheelchair of FIG. 9 with a portion of the secondary front-wheel attachment of the second embodiment installed on it.

### DETAILED DESCRIPTION OF EXAMPLE EMBODIMENTS

The present invention relates to a wheelchair attachment with a selectively deployable secondary front-wheel set for use in traversing rough terrain. The attachment is operable to deploy the secondary front-wheel set between a disengaged up position and a deployed down position. In the disengaged up position, the secondary front wheels are up off the supporting ground, so the primary front wheels of the wheelchair are in contact with the ground for use in traversing smooth terrain in the normal use of the wheelchair. But in the deployed down position, the secondary front wheels are moved down into contact with the supporting ground for use in traversing rough terrain. At the same time, the primary front wheels are removed from contact with the ground and out of the way so that they are no longer in use, such that only the secondary front wheels contact the ground and support the weight of the wheelchair. In some embodiments, the attachment is provided as a retrofit device for installation on existing wheelchairs. And in other embodiments, the attachment is integrally provided as a component of new wheelchairs. It should be noted that, as used herein, the terms “supporting ground” and “ground” refer to any underlying support surface across which the wheelchair traverses, and is not intended to refer to only the surface of the earth.

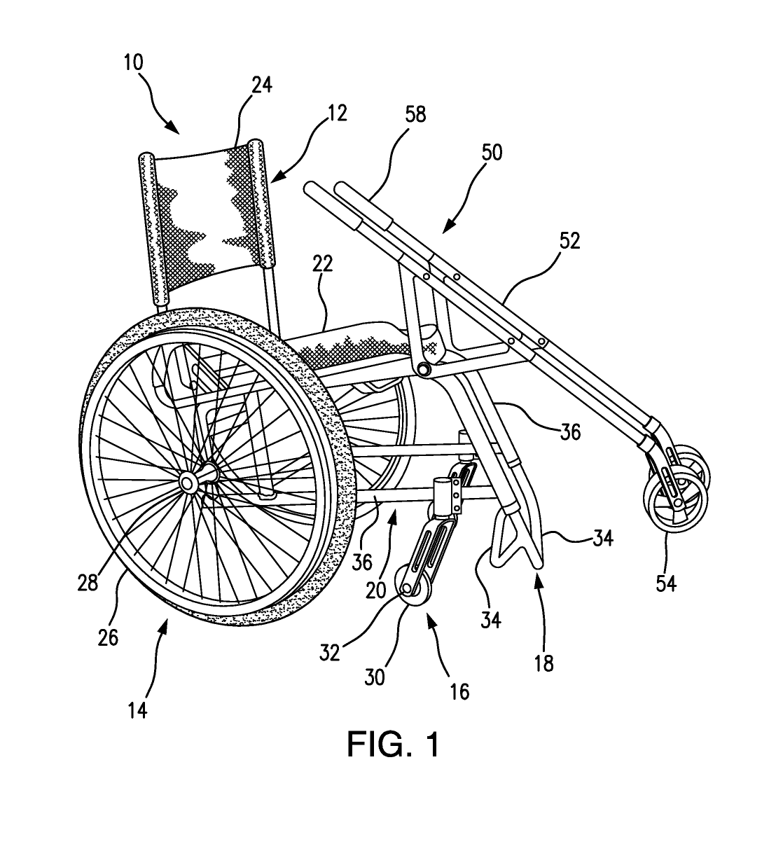

FIGS. 1-5 show a wheelchair 10 including a secondary front-wheel attachment 50 according to a first example embodiment of the present invention. The wheelchair 10 includes a sitting assembly 12, a rear wheel assembly 14, a front wheel assembly 16, and a foot rest 18, all mounted to a frame 20. The sitting assembly 12 includes a generally horizontal seat 22 and a generally vertical backrest 24. The rear wheel assembly 14 includes two large rear wheels 26 mounted on rear axles 28, and the front wheel assembly 16 includes two small front wheels 30 mounted on front axles 32, with the rear and front wheels spaced apart and positioned on the left and right sides of the frame 20. The foot rest 18 extends downward from the frame 20 and includes at least one generally horizontal member 34 such as a bar (two are depicted), a plate, or the like. The foot rest 18 can be a separate assembly that is mounted to the frame 20 or it can be provided as an integral section of it. And the frame 20 includes a plurality of structural members 36 such as the tubular metal members shown mounted together by conventional fasteners such as nuts and bolts, welding, or the like. As such, the wheelchair 10 can be of a conventional type that is known in the art.

The wheelchair attachment 50 includes at least two pivotal control arms 52, at least two secondary front wheels 54, at least one cross member 56, and at least one operating handle 58. In the depicted embodiment, there are two pivot arms 52, two secondary front wheels 54 (one per pivot arm), one cross member 56 (extending between the two pivot arms), and two operating handles 58 (one per pivot arm). In other embodiments, there are more or fewer of these components, as may be desirable to some users in some applications. Thus, instead of a pair of secondary front wheels, in some embodiments there is only a single one of them and in other embodiments there are three of them.

The depicted pivotal control arms 52 are pivotally mounted to the chair frame 20 on the left and right sides of the chair 10, and the cross member 56 extends between them so that the arms pivot together as one. The pivot arms 52 are typically generally vertically arranged (when viewed from the front) with the cross member 56 extending generally horizontally (or diagonally or otherwise) between them. The pivot arms 52 and the cross member 56 can be provided by elongate structural members such as tubes or bars and made of a material that is lightweight but strong such as aluminum. The pivot arms 52 and the cross member 56 are typically generally linear, though in some embodiments they are curved, angled, or otherwise non-linear for strength and/or leverage. The pivot arms 52 can be mounted to the frame 20 by conventional pivot-pin mechanisms or other conventional pivotal couplings known in the art. And the cross member 56 can be attached to the pivot arms 52 by conventional fasteners such as welding or nuts/bolts, or they can be integrally formed as one part. Although the depicted embodiment includes two operating handles 58, in other embodiments the wheelchair attachment includes only one operating handle (e.g., lateral- or central-positioned) and the force applied to it is transmitted to the other pivot arm via at least one cross member to provide for a smooth and easy operation.

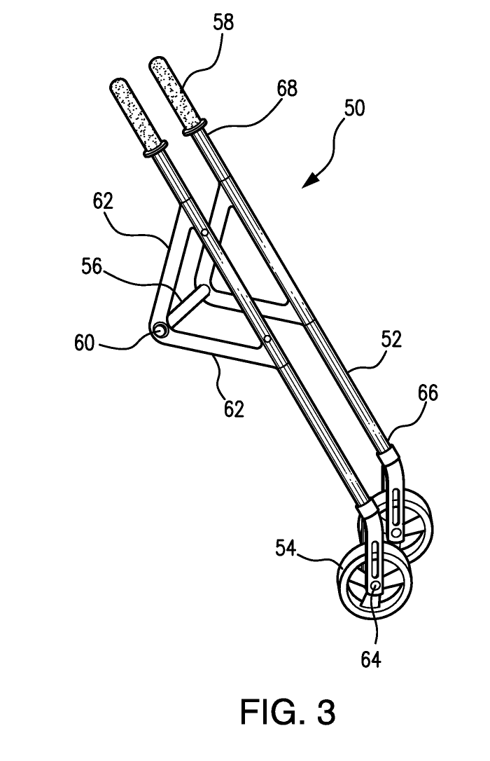

As shown more particularly in FIG. 3, the cross member 56 extends generally horizontally between the pivotal control arms 52 at the pivot point 60, with the cross member extending through the pivot arms and the chair frame 20 to thereby form the pivot pin. In other embodiments, the cross member extends generally horizontally between the pivot arms above or below the pivot point and does not form the pivot pin. And in other embodiments, the cross member is eliminated from the design (or included for other reasons but does not interconnect the pivot arms) and instead the pivot arms operate independently of each other.

In addition, the attachment 50 can include offset members 62 extending rearward from the pivot arms 52 to offset the pivot point 60 from the pivot arms (and thus typically from the handles 58 and/or the secondary front wheels 54) while keeping the secondary front wheels clear of the rear wheels 26. In the depicted embodiment, for example, the attachment 5 includes two offset members 62 for each respective one of the pivot arms 52, with the offset members diagonally arranged to cooperative with the respective pivot arm form a triangle for structural strength. In other embodiments, more or fewer offset members are provided, they cooperatively form squares, circles, or other regular or irregular shapes for structural strength, and/or they extend forward (or both rearward and forward) from the pivot arms. And in still other embodiments, the pivot points are located on and along (and thus generally aligned with) the depicted pivot arms and handles, with no offset members included.

The secondary front wheels 54 rotate on axles 64 and are typically mounted to lower sections 66 of the pivot arms 52 by conventional swivel couplings (e.g., for 360-degree swiveling). The secondary front wheels 54 are in addition to the primary front wheels 30, but are larger in diameter and/or width for use in traversing rough terrain. In typical commercial embodiments, for example, the secondary front wheels 54 typically have a diameter of about one and one-half inch to about two inches, and preferably have a diameter of about six inches. As noted above, the smaller primary front wheels 30 typically have a diameter of about three inches and a width of about one-half inch, and are thus smaller relative to the secondary front wheels 54. In addition, the secondary front wheels 54 can be made of rubber (or another soft resilient material) and be hollow and inflatable with air. In other embodiments, the secondary front wheels have other sizes and constructions selected for example for the particular terrain to be traversed, as is known for conventional sports and low-profile wheelchairs. And in still other embodiments, the secondary front wheels are smaller than the primary front wheels (e.g., with the primary front wheels better for use on rough terrain and the secondary front wheels better for use on smooth terrain, for use by persons who spend more time on rough terrain than smooth terrain).

The operating handles 58 are provided by hand grips and used to manually pivot the pivotal control arms 52. In the depicted embodiment, for example, the operating handles 58 are positioned on upper sections 68 of the pivot arms 52 generally inline with them. In other embodiments, the operating handles extend generally horizontally inward toward each other. In yet other embodiments, a single operating handle is provided and it is positioned on the cross member (at about its midpoint so the handle is between the user's knees), on one of the pivot arms (the other pivot arm need not include an upper section), or another component of the attachment. And in still other embodiments, the operating handle(s) are integrally formed and defined by one or more of the pivot arms and/or the cross member(s).

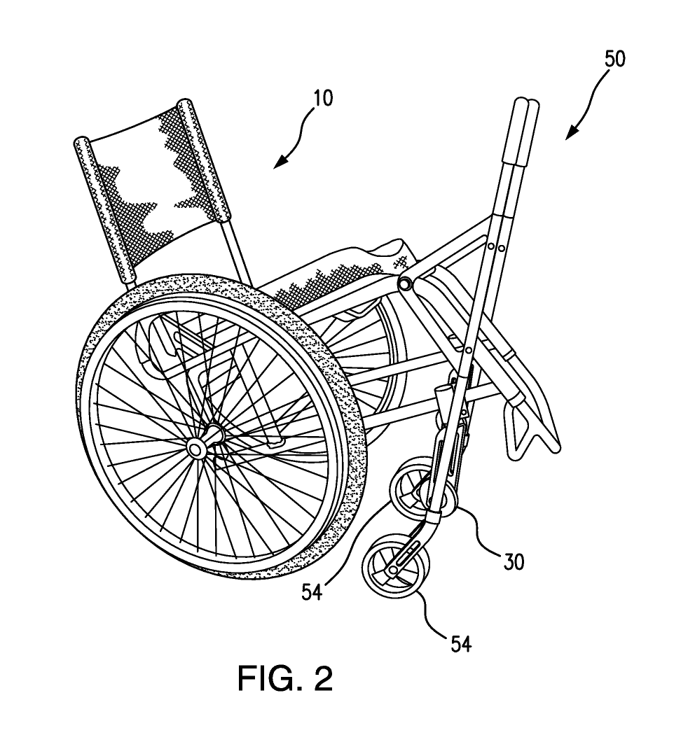

In use, the operating handles 58 are used to apply a force to the pivotal control arms 52 to pivot the secondary front wheels 54 of the wheelchair attachment 50 from a disengaged up position (FIG. 1), through an intermediate position, and to a deployed down position (FIG. 2), and back. In the disengaged up position, the secondary front wheels 54 are pivoted up and off the ground, so only the primary front wheels 30 of the wheelchair 10 are in contact with the ground and being used. In this position, the support seat 22 is typically generally horizontal, as this is typically the position of normal/primary use of the wheelchair 10. In the deployed down position, the secondary front wheels 54 are pivoted down into contact with the ground and being used, so the primary front wheels 30 are now lifted and thus removed from contact with the ground such that they are no longer in use. In typical commercial embodiments, for example, the primary front wheels 30 are lifted about five inches off of the ground for providing clearance (e.g., over obstacles resting on the ground such as rocks and twigs) while traversing rough terrain, as their contact with the ground when traversing rough terrain could impede travel. And preferably the secondary front wheels 54 are now positioned directly below the primary front wheels 30 (or substantially so) for the overall stability of the wheelchair 10. In this deployed down position, the support seat 22 is tilted backward (its front is higher than its rear), as the now-engaged larger-diameter secondary front wheels 54 cause this tilting. In the intermediate position depicted, the secondary front wheels 54 of the wheelchair attachment 50 and the primary front wheels 30 of the wheelchair 10 are momentarily all in contact with the ground as the pivot arms 52 are pivoting between the disengaged up and deployed down positions.

In the depicted embodiment, the wheelchair attachment 50 is designed so that the user pushes the operating handles 58 forward to deploy the secondary front wheels 54 and pulls the handles backward to disengage them. This arrangement allows the user to push the handles 58 forward while the support seat 22 is generally horizontal and pull the handles backward while the support seat tilts backward. This provides leverage to reduce the amount of force required and thereby make it easier to deploy and disengage the secondary front wheels 54, and helps prevent the user from accidentally pulling himself/herself out of the wheelchair 10. In other embodiments, the wheelchair attachment is designed so that the user pulls the handles backward to deploy the secondary front wheels and pushes the handles forward to disengage them.

In this way, the user can quickly and easily deploy the secondary front wheels 54, and at the same time automatically disengage the primary front wheels 30, in order to traverse rough terrain. And afterward, the user can then quickly and easily disengage the secondary front wheels 54, and at the same time automatically reengage the primary front wheels 30, in order to again traverse smooth terrain. Significantly, the user can do all this without having to get out of the wheelchair 10 to change out the front wheels 30 or 54 or manipulate any other mechanism.

One or more mechanical locks can be provided (e.g., one for each pivot arm 52 or one for both pivot arms) to secure the pivot arms in the disengaged up and/or deployed down positions for use and to release them for pivoting. Such mechanical locks can be provided by detents, spring-loaded pin assemblies, clasps, clamps, hooks, hinged arms, or other locking mechanisms known in the art.

In the depicted embodiment, the attachment 50 is an aftermarket product that can be retrofit-attached to the wheelchair 10 without physically altering the frame 20 of the chair. This can be beneficial because altering the frame 20 would typically void any existing warranty on the chair 10. The retrofitting method can thus include attaching the pivot arms 52 to the frame 20 at the pivot point 60 through lateral holes that are pre-existing in the frame of the chair 10. Many conventional wheelchairs 10 have such lateral holes in their frames 20 for adjusting the height of the footrest 18, and a plurality of pivot points 60 can be provided on the pivot arms 52 to allow for use with various different chairs. In other embodiments, the attachment mounts to the chair frame by clamps or other couplings that do not require physically altering the frame of the chair. In still other embodiments, the attachment is designed for attaching to new holes custom-formed (e.g., by drilling) in an existing wheelchair. And in yet other embodiments, the attachment is included with a new wheelchair without any retrofitting method required (e.g., manufactured as an integral component of the wheelchair at the factory, or installed onto the wheelchair by the dealer).

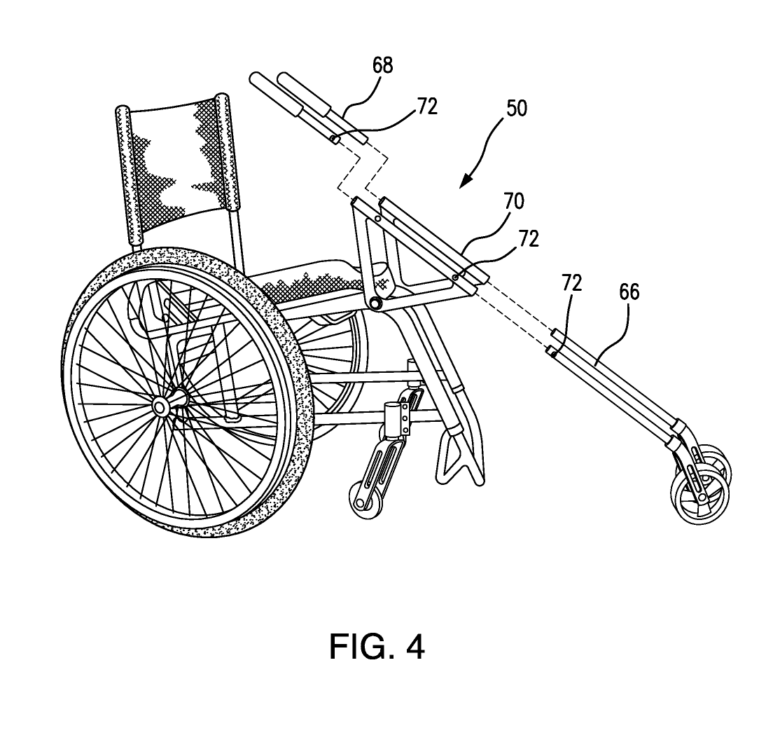

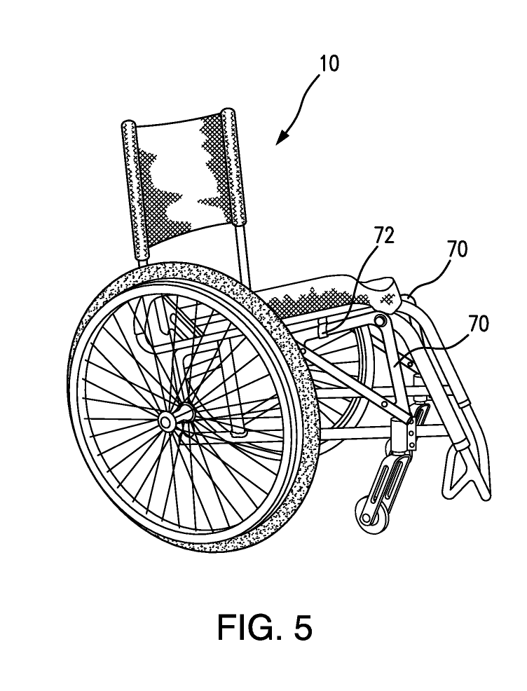

As shown in FIGS. 4-5, the attachment 50 of this embodiment can be disassembled (when in the disengaged up position) and stored compactly when not in use for the convenience of the user. The upper and lower sections 66 and 68 of the pivot arms 52 detach from an intermediate section 70 that typically includes the pivot point 60. In the depicted embodiment, the upper and lower sections 66 and 68 are detachably coupled to the intermediate section 70 by spring-loaded pin connectors 72 on overlapping telescopic segments of each adjacent section (FIG. 4). In other embodiments, the upper and lower sections 66 and 68 are connected to the intermediate section 70 by other detachable couplings such as threaded-screw assemblies, quick-release couplings, compression/friction fit couplings, clamps, or other detachable couplings known in the art. With the upper and lower sections 66 and 68 detached, the remaining intermediate sections 70 each can be pivoted out of the way into a storage position and secured in place by a clip 72 or other releasable retainer mechanism (FIG. 5). The upper and lower sections 66 and 68 can be stored in a compartment under or behind (or integrally formed into) the seat 22 or backrest 24 of the sitting assembly 12, and such a compartment can be provided for attachment thereto as part of a retrofit kit (or integrally provided in a customized seat or backrest that is part of a retrofit kit). In other embodiments, the attachment in its entirety is removable from the frame of the chair, with the pivot pins having a quick-release feature and with the cross member detachable from the pivot arms for compact storage. And in still other embodiments, the attachment is foldable, telescopically retractable, or otherwise collapsible into a compact arrangement for storage when not in use, for example, the upper and lower sections can be inwardly foldable relative to the intermediate section (after being released from a locked-in-place use position).

In the depicted embodiment, the wheelchair attachment 50 is designed so that the user applies a push/pull force to the operating handles to pivot the secondary front wheels 54 between the deployed down and disengaged up positions. In other embodiments, the wheelchair attachment is designed so that the user applies a differently-directed force to the operating handles to move the secondary front wheels between the deployed down and disengaged up positions in a pivoting or other (non-pivotal) motion. For example, in some other embodiments, the wheelchair attachment is designed so that the user applies a lateral, rotary, and/or other-direction force to the operating handles (or to the control arms or another component of the attachment) to move the secondary front wheels between the deployed down and disengaged up positions. In other alternative embodiments, instead of pivoting as described above, the control arms that the secondary front wheels are mounted to move between the deployed down and disengaged up positions by moving linearly up and down (e.g., telescopically or spiral-rotationally), pivoting/folding laterally inwardly towards each other and/or by moving outwardly away from each other, and/or by moving in another motion. In embodiments in which the operating handles are not moved in a manner that causes an opposite movement of the secondary front wheels (e.g., rotating handles cause wheels to pivotal between positions), a force-converting mechanism is provided and/or upper sections and handles of the control arms are modified. And in still other alternative embodiments, the primary front wheels are relocated onto the attachment and mounted there with a mechanism adapted so that they move up when the secondary front wheels are deployed down.

In other alternative embodiments, the attachment includes an actuator for powered operation and a control unit that the user operates to control the position of the secondary front wheels, with the control unit operably coupled to the actuator, which is in turn operably coupled to the arms that the wheels are mounted to. For example, the actuator can be provided by an electric motor coupled to the attachment arms for driving them between the deployed down and disengaged up positions. In such embodiments, the operating handle that is manipulated to move the secondary wheels between the disengaged up and deployed down positions is provided by one or more buttons, knobs, control sticks, etc. of the control unit.

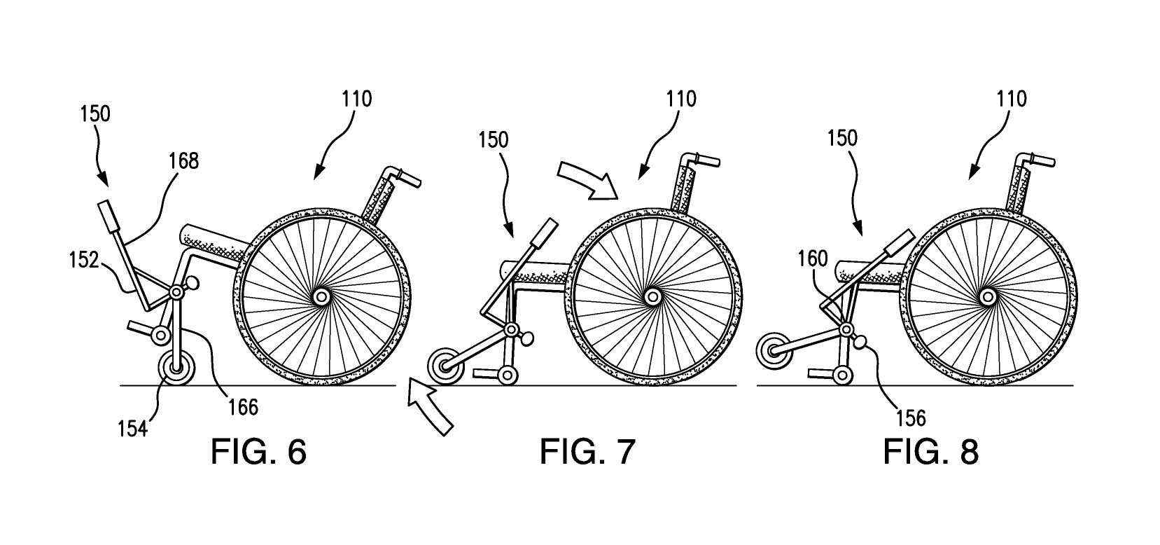

FIGS. 6-8 show a wheelchair 110 including a secondary-front-wheel attachment 150 according to a second example embodiment of the present invention. The wheelchair 110 and the attachment 150 are similar to those of the first embodiment described above, with the secondary wheels 154 pivoting between a deployed down position (FIG. 6), an intermediate position (FIG. 7), and a disengaged up position (FIG. 8). In this embodiment, the axes of the secondary wheels 154 are directly below the pivot point 160 when the attachment 150 is in the deployed down position (see FIG. 6). To accomplish this, in the deployed down position the lower sections 166 and the upper section 168 of the pivot arms 152 can be generally vertical and offset from each other by one or more offset members (e.g., the two depicted offset members that cooperate with the pivot arm upper section for form a triangle). This provides for high strength and smooth rolling. In addition, in this embodiment the cross member 156 is positioned behind and offset from the pivot point 160 in a more out-of-the-way position, and it can be connected between rearward-extending ends of two of the offset members.

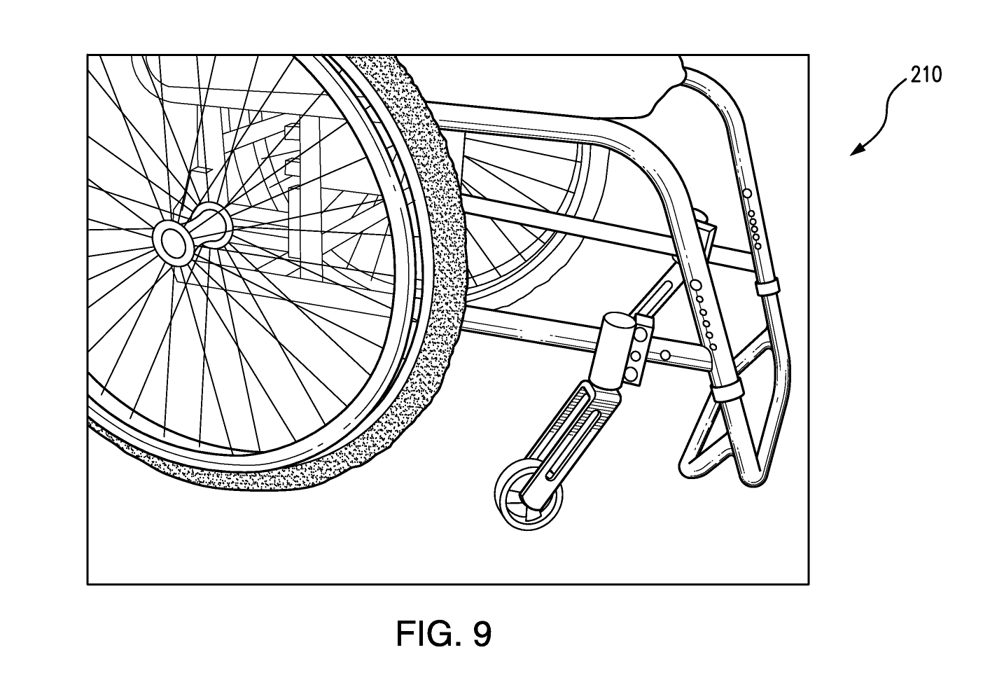

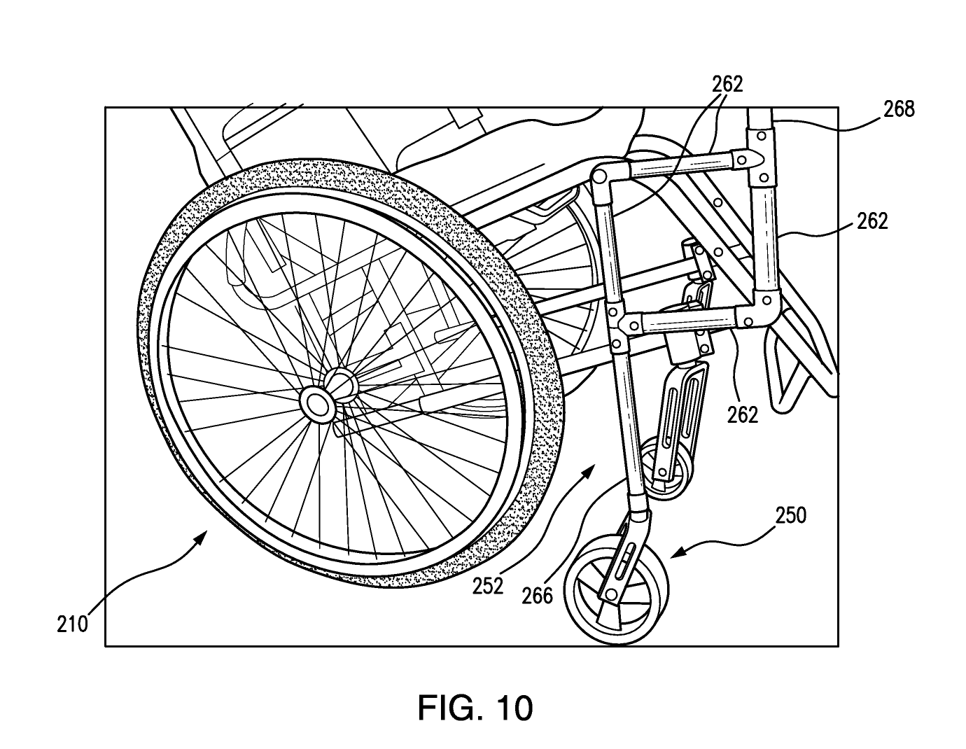

FIGS. 9-10 show a wheelchair 210 including a secondary-front-wheel attachment 250 according to a third example embodiment of the present invention. FIG. 9 shows the wheelchair 210 without the secondary-front-wheel wheelchair attachment 250. And FIG. 10 shows the wheelchair 210 with only one pivot arm 252 of the secondary-front-wheel attachment 250 attached in place in the deployed down position. The wheelchair 210 and the attachment 250 of this embodiment are similar to those of the first embodiment described above. In this embodiment, the offset members 262 are horizontal and vertical to cooperatively form a rectangle (e.g., a square in the depicted embodiment), and the upper and lower sections 268 and 266 of the pivot arms 252 are parallel but offset from each other by the horizontal dimension of the rectangle.

It is to be understood that this invention is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the claimed invention has been shown and described in example forms, it will be apparent to those skilled in the art that many modifications, additions, and deletions can be made therein without departing from the spirit and scope of the invention as defined by the following claims.

What is claimed is:

1. A secondary-front-wheel attachment for a wheelchair having primary front wheels with a first size, the attachment comprising:
at least two control arms movably coupled to the wheelchair and each having a lower section;
at least two secondary front wheels mounted to the lower sections of the control arms and having a second size that is different from the first size of the primary front wheels; and
at least one operating handle operably coupled to at least one of the control arms and movable to cause the secondary front wheels to move between a disengaged up position and a deployed down position,
wherein in the disengaged up position the secondary front wheels are positioned up off the ground so that the primary front wheels are in contact with the ground for use, and wherein in the deployed down position the secondary front wheels are positioned down in contact with the ground for use so that the primary front wheels are now positioned up out of contact with the ground and are no longer for use.

2. The wheelchair attachment of claim 1, wherein the control arms are pivotally mounted to the wheelchair so that the secondary front wheels pivot between the disengaged up and deployed down positions.

3. The wheelchair attachment of claim 2, wherein the secondary front wheels pivot from the disengaged up position to the deployed down position upon application of a pushing forward force to the operating handle, and the secondary front wheels pivot from the deployed down position to the disengaged up position upon application of a pulling backward force to the operating handle

4. The wheelchair attachment of claim 2, wherein the wheelchair has a support seat, with the attachment in the disengaged up position the seat is generally horizontal, and with the attachment in the deployed down position the seat is tilted backward.

5. The wheelchair attachment of claim 2, wherein the wheelchair includes a frame with existing lateral holes and the attachment includes one or more pivot pins that extend through one or more of the lateral holes, without physically altering the wheelchair frame, to pivotally mount the attachment to the wheelchair frame.

6. A method of retrofitting the attachment onto the wheelchair of claim 2, comprising installing at least one pivot pin through an existing lateral hole in a frame of the wheelchair to pivotally mount the pivotal control arms to the wheelchair without physically altering the wheelchair frame.

7. The wheelchair attachment of claim 1, further comprising at least one cross member extending laterally between the control arms.

8. The wheelchair attachment of claim 8, wherein the cross member extends through the control arms and forms two pivot pins to which the control arms are pivotally mounted.

9. The wheelchair attachment of claim 8, wherein the cross member is positioned rearward of the control arms.

10. The wheelchair attachment of claim 1, wherein the control arms each include an upper section and a lower section, further comprising at least one offset member extending between and offsetting the upper and lower sections of the control arms.

11. The wheelchair attachment of claim 10, wherein the offset members, alone or in cooperation with the control arms, form a triangle or a rectangle.

12. The wheelchair attachment of claim 1, wherein the control arms each include an upper section and a lower section that are detachably coupled together so that they can be disassembled from each other for storage in a compact arrangement.

13. The wheelchair attachment of claim 12, wherein the control arms each include an intermediate section positioned between the respective upper and lower section, the attachment mounts to the wheelchair at the intermediate sections of the control arms, and with the upper and lower sections of the control arms removed from the respective intermediate sections then the respective intermediate sections can be pivoted to a storage position.

14. The wheelchair attachment of claim 1, wherein the second size of the secondary front wheels is larger than the first size of the primary front wheels such that the primary front wheels are suitable for traversing smooth terrain and the secondary front wheels are suitable for traversing rough terrain.

15. A secondary-front-wheel attachment for a wheelchair having a frame with primary front wheels in a first size and with a support seat, the attachment comprising:
two control arms pivotally coupled to the wheelchair frame and each having a lower section;
a cross member extending laterally between the control arms;
two secondary front wheels mounted to the lower sections of the control arms and having a second size that is larger than the first size of the primary front wheels such that the primary front wheels are suitable for traversing smooth terrain and the secondary front wheels are suitable for traversing rough terrain; and
two operating handles operably coupled to the control arms and movable to cause the secondary front wheels to pivot between a disengaged up position and a deployed down position,
wherein in the disengaged up position the secondary front wheels are pivoted to up off the ground so that the primary front wheels are in contact with the ground for use, wherein in the deployed down position the secondary front wheels are pivoted to down in contact with the ground for use so that the primary front wheels are now positioned up out of contact with the ground and are no longer for use, wherein the secondary front wheels pivot from the disengaged up position to the deployed down position upon application of a pushing forward force to the operating handle, and the secondary front wheels pivot from the deployed down position to the disengaged up position upon application of a pulling backward force to the operating handle, wherein with the attachment in the disengaged up position the seat is generally horizontal and with the attachment in the deployed down position the seat is tilted backward, and wherein the operating handle can be quickly and easily manipulated to pivot the secondary front wheels between the disengaged up and deployed down positions without having to get out of the wheelchair and change out the primary front wheels.

16. A method of retrofitting the attachment onto the wheelchair of claim 15, comprising installing at least one pivot pin through an existing lateral hole in the frame of the wheelchair to pivotally mount the pivot arms in place without physically altering the wheelchair frame.

17. The wheelchair attachment of claim 15, wherein the pivotal control arms each include an upper section and a lower section, further comprising at least one offset member extending between and offsetting the upper and lower sections of the pivotal control arms.

18. The wheelchair attachment of claim 15, wherein the pivotal control arms each include an upper section and a lower section that are detachably coupled together so that they can be disassembled from each other for storage in a compact arrangement.

19. A wheelchair, comprising:
a sitting assembly, a rear wheel assembly, and a front wheel assembly, all mounted to a frame, the front wheel assembly including two primary front wheels having a first size; and
a secondary front-wheel attachment including two control arms movably coupled to the wheelchair frame and each having a lower section, two secondary front wheels mounted to the lower sections of the control arms and having a second size that is different from the first size of the primary front wheels, and at least one operating handle operably coupled to at least one of the control arms and movable to cause the secondary front wheels to move between a disengaged up position and a deployed down position, wherein in the disengaged up position the secondary front wheels are positioned up off the ground so that the primary front wheels are in contact with the ground for use, and wherein in the deployed down position the secondary front wheels are positioned down in contact with the ground for use so that the primary front wheels are now positioned up out of contact with the ground and are no longer for use.

20. A method of retrofitting the attachment onto the wheelchair of claim 19, comprising installing at least one pivot pin through an existing lateral hole in the frame of the wheelchair to pivotally mount the pivotal control arms to the wheelchair without physically altering the wheelchair frame.
